(19) United States
(12) Patent Application Publication
(10) Pub. No.: US 2024/0169212 A1
(43) Pub. Date: May 23, 2024

(54) SYSTEM FOR TRAINING MACHINE LEARNING MODELS USING FEDERATED LEARNING

(71) Applicant: Samsung Electronics Co., Ltd., Gyeonggi-do (KR)

(72) Inventors: Andrea TASSI, Middlesex (GB); Joan Pujol ROIG, Middlesex (GB); Yue WANG, Middlesex (GB)

(21) Appl. No.: 18/511,455

(22) Filed: Nov. 16, 2023

(30) Foreign Application Priority Data
Nov. 21, 2022 (GB) 2217392.6
Oct. 16, 2023 (GB) 2315821.5

(51) Int. Cl. G06N 3/098; H04W 8/22

(52) U.S. Cl. CPC G06N 3/098; H04W 8/22

(57) ABSTRACT

A method and system for more efficient federated learning (FL) of a machine learning (ML) model using user equipment (UEs) in cellular networks are disclosed. In particular, a system is provided for reducing the impact of poor channel conditions in a cellular network on the FL process. The cellular network may be a 5G, 6G or next generation cellular network. Advantageously, this disclosure creates redundancies in the transmission of FL trained model parameters to reduce the likelihood of an FL training process being stalled by a failure in transmission of data between UEs and a central parameter server which updates an ML model using data received from UEs.

### CROSS-REFERENCE TO RELATED APPLICATION(S)

This application is based on and claims priority under 35 U.S.C. § 119 to United Kingdom Patent Application Nos. 2217392.6 and 2315821.5, filed on Nov. 21, 2022, and Oct. 16, 2023, respectively, in the United Kingdom Intellectual Property Office, the disclosure of each of which is incorporated herein by reference in its entirety.

### BACKGROUND

### 1. Field

This disclosure generally relates to more efficient federated learning (FL) of a machine learning (ML) model using user equipment (UE) in cellular networks. In particular, this disclosure provides a system for reducing the impact of poor channel conditions in a cellular network on the federated learning process.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality (AR) glasses, virtual reality (VR) headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have 1/10 the radio latency thereof.

In order to accomplish such a high data rate and an ultra-low latency, it has been considered to implement 6G communication systems in a terahertz band (for example, 95 GHz to 3 THz bands). It is expected that, due to a more severe path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multi-antenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performance, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Machine learning techniques are ubiquitous and have been shown to be very successful in analyzing and making predictions in a variety of fields, using a variety of different data types. The key to successful ML/AI models is the availability of large amounts of training data. Daily, billions of connected devices record data in various settings. Thus, a multitude of valuable datasets already exists, fragmented across several user devices. Gathering and consolidating these fragmented datasets in a centralized location often proves impossible though. This may be due to communication-related issues, such as devices having very limited communication link budgets. Additionally, a distributed dataset may comprise on private information (such as health-related data), which the end-user might not be willing or allowed to share across the Internet. This issue may be solved by end-users locally training machine learning models on their training data and thus preserving the privacy of the local datasets, i.e., by employing an FL algorithm. The locally trained and improved model parameters may then be transmitted to a central server that incorporates the knowledge gained locally into a global model.

However, if any of the user devices participating in the FL process are unable to transmit the results of their training to a centralized server, the whole FL process may stall. This may be the case when any user device is no longer able to communicate the results of their training to the centralized server due to a limited communication budget or a bad wireless connection on, for example, a 5G network.

Therefore, a method is needed for improved data transfer during an FL process.

### SUMMARY

In accordance with an aspect of the disclosure, a parameter server for training machine learning (ML) models in a cellular network is provided. The parameter server includes at least one ML model for training, at least one module for updating the at least one ML model as a response to a federated learning (FL) task being executed, and a scheduler for managing executions of FL tasks in the cellular network. For each FL task, the scheduler is configured to select a set of user equipments (UEs) from the plurality of subscribing UEs as being suitable for performing the FL task, determine a clustering policy for the FL task, which specifies how to group the selected set of UEs into a plurality of clusters, and instruct each cluster of the plurality of clusters to perform the FL task.

In accordance with another aspect of the disclosure, a UE for training ML models in a cellular network is provided. The UE includes storage storing a plurality of training data items and at least one processor. The at least one processor of the UE is configured to receive a data coding optimization policy, receive, from a parameter server, instructions to perform an FL task with respect to an ML model, generate, for at least one training data item in the storage, a coded training data item, based on the received per-cluster data coding optimization policy, and transmit the at least one generated coded training data item to a cluster of UEs or to a node connected to the UEs in the cluster.

In accordance with another aspect of the disclosure, a method performed by a parameter server for training ML models using FL in a cellular network is provided. The method includes selecting a set of subscribing UEs from a plurality of subscribing UEs in the cellular network as being suitable for performing a FL task, where each subscribing UE has subscribed to perform at least one federated learning task, determining a clustering policy for the federated learning task, which specifies how to group the selected set of subscribing UEs into a plurality of clusters, and instructing each cluster of the plurality of clusters of subscribing UEs to perform the FL task.

In accordance with another aspect of the disclosure, a method performed by a coordinator for training ML models in a cellular network is provided. The method includes receiving, from a parameter server, a clustering policy for an FL task and information on a set of UEs, and grouping the set of UEs into a plurality of clusters based on the clustering policy, wherein the clustering policy specifies how to group the set of UEs into the plurality of clusters, and wherein the set of UEs is selected from a plurality of UEs in the cellular network as being suitable for performing the FL task.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating the problem of stragglers within a federated learning (FL) process;

FIG. 2 illustrates a block diagram of a system for training ML models within an open radio-access network (ORAN) cellular network, according to an embodiment;

FIG. 3 is a schematic diagram illustrating a process to create and execute an FL task, according to an embodiment;

FIG. 4 is a flow diagram illustrating a process for UEs to communicate subscription requests and status updates to a scheduler, according to an embodiment; and

FIG. 5 is a flow diagram illustrating a process to perform FL within a cellular network, according to an embodiment.

### DETAILED DESCRIPTION

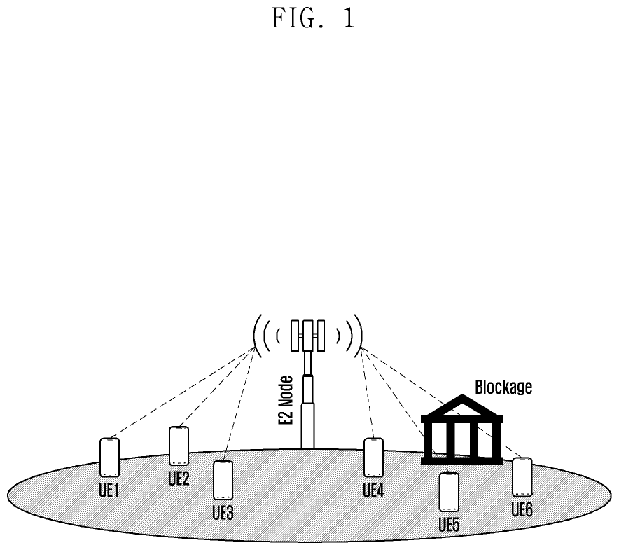

FIGS. 1-5, discussed below, and the various embodiments used to describe the principles of the disclosure are by way of illustration only and should not be construed in any way to limit the scope of the disclosure. Those skilled in the art will understand that the principles of the disclosure may be implemented in any suitably arranged system or device.

Broadly speaking, embodiments of the disclosure provide a method and system for more efficient FL of an ML model using UEs in cellular networks. In particular, this disclosure provides a system for reducing the impact of poor channel conditions in a cellular network on the FL process. The cellular network may be a 5G, 6G or next generation cellular network. Advantageously, the embodiments of the disclosure create redundancies in the transmission of FL trained model parameters to reduce the likelihood of an FL training process being stalled by a failure in transmission of data between UEs and a central parameter server which updates an ML model using data received from UEs.

FL enables an ML model to be trained with data from multiple UEs, also referred to herein as user devices, without the data leaving the UEs. In particular, a centralized parameter server is set to have access to a number of UEs wishing to take part in a distributed model training (namely, an FL workload). According to the original FL principle, the parameter server is responsible for (i) the model distribution to the UEs, (ii) model parameter updating, and (iii) distributed training coordination. By the end of each learning step: (i) All the UEs taking part in an FL workload are expected to report their locally-calculated partial gradients to the parameter server; (ii) In turn, the parameter server combines the partial gradients to obtain the global gradient and updates the learned parameters; and (iii) The learned parameters are then broadcast to all the UEs taking part in an FL workload.

FIG. 1 is a schematic diagram illustrating the problem of stragglers within an FL process.

Referring to FIG. 1, each UE taking part in a particular FL workload or task communicates their model parameters (which may be partial gradients, weights, biases or any other parameters of an ML model), to a server for aggregation. In this particular example, each UE may communicate with the server via other components in the cellular network, such as an E2 node or a base station. However, UE5 and UE6 are unable to transmit their model parameters within a required period of time because of a poor communication link with the E2 node. Thus, UE5 and UE6 are considered “stragglers” due to a reduced communication link budget determined by a blockage.

Should any of the UEs be unable to successfully communicate their locally-calculated parameters to the parameter server, the traditional FL framework stalls. “Straggling UEs” or “stragglers” are those UEs unable to communicate one or more parameters due to UE-related limitations (e.g., lack in central processing unit (CPU) capacity, insufficient memory resources, etc.) or limitations pertaining to poor channel conditions between the UE and the serving E2 node/base station.

This disclosure provides techniques to combine the random coding principle for point-to-multipoint communications with the distributed training phase of an FL workload. In doing so, the probability of having a large number of stragglers that would undermine the training process is drastically reduced. As such, the techniques provided by this disclosure advantageously impact scenarios where UEs taking part in an FL workload become stragglers only due to poor channel conditions.

In the context of 6G (but not limited to), it is widely accepted that distributed AI/ML is expected to be one of the key enabling technologies to meet tight quality of service (QOS) constraints in networks with a vast number of users requesting high-data-rate services. As such, it is increasingly important for 5G systems to provide assistance to FL operations. Partially, due to bandwidth limitations and/or privacy concerns, users are expected to be unable/unwilling to share locally stored data with a centralized server wishing to train AI models on users' data. As a result, FL is one of the promising frameworks for carrying out distributed learning without collating users' data at a central location.

As already noted above, a key drawback of FL occurs when user devices taking part in a distributed learning (in this case, FL) workload are unable to share their locally calculated model parameters with a centralized server, due to poor channel conditions. This rather plausible situation would be sufficient to challenge the practicality of running distributed learning workloads in 6G networks. This disclosure addresses this limitation, thus increasing the confidence of running to completion FL workloads in a mobile environment.

Being able to run FL workloads confidently has tangible benefits in 5G and 6G networks, such as (but not limited to): connectivity optimization of dense multicell networks; user device behavior prediction; and channel estimation and signal detection.

Existing techniques optimize the random code used in FL workloads with respect to the UE experiencing the worst propagation conditions amongst the UEs. This approach can lead to unnecessary communication overheads when: (i) the number of stragglers is significantly smaller than the overall number of UEs taking part in an FL workload, or (ii) when the channel condition experienced by the stragglers are substantially worse than the channel conditions experienced by the rest of the UEs. In contrast, this disclosure imposes that the UEs taking part in an FL workload are clustered according to a set of clustering criteria. Subsequentially, the parameter server optimizes the random code on a per-cluster basis. In particular, the code optimization is performed against the straggler experiencing the worst channel conditions within each cluster. As such, the overall communication overhead is expected to be reduced.

Existing techniques assume that the set of UEs regarded as stragglers do not change during the execution of an FL workload. This is a rather unrealistic assumption due to the mobile nature of some UEs as well as the dynamicity of the communication channel and physical environment. In contrast, this disclosure makes provisions for the random code to be re-optimized across one or more clusters during the execution of an FL workload. This disclosure also makes provisions for the UEs taking part in the FL workload to be re-clustered (and the code subsequentially re-optimized across the cluster) during the execution of an FL workload.

Existing techniques assume that UEs taking part in an FL workload transmit back to the parameter server both the partial gradients (calculated over the locally available pieces of a dataset) and coded examples—namely, labelled training examples obtained by linearly combining in a rateless fashion locally available training examples. Then, the parameter server calculates partial gradients over the successfully received coded examples. In contrast, this disclosure removes the aforementioned plurality of data types that each UE is expected to transmit to the parameter server. In its place, each UE generates and multicasts coded examples within the cluster that it belongs to. Furthermore, this disclosure makes provisions for each UE taking part in an FL workload to transmit to the parameter server only gradients calculated over locally available training examples or locally generated coded examples (this includes also coded examples that might have been received from other UEs belonging to the same cluster).

In a first approach of this disclosure, there is provided a system for training ML models using FL in a cellular network. The system includes a plurality of subscribing UEs, where each subscribing UE has subscribed to perform at least one FL task, and a plurality of non-subscribing UEs, where each non-subscribing UE has not subscribed to perform at least one FL task; and a parameter server for controlling the training of ML models by the cellular network. The parameter server includes at least one ML model for training; at least one module for updating the at least one ML model in response to a FL task being executed; and a scheduler for managing execution of FL tasks in the cellular network, wherein for each FL task, the scheduler selects a set of UEs from the plurality of subscribing UEs as being suitable for performing the FL task; defining a clustering policy for the FL task, which specifies how to group together the selected set of UEs into a plurality of clusters; and instructing each cluster of the plurality of clusters to perform the FL task.

According to an embodiment, a scheduler is provided which oversees the execution to completion of an FL task by clusters of UEs, so that the impact of stragglers/straggling UEs is reduced or removed entirely. This is advantageous for a number of reasons. First, instead of simply expecting every UE in the cellular network to participate in the FL process, the scheduler determines which UEs in the network are able to, and have explicitly subscribed to, perform one or more FL tasks. This means that UEs that are unable to participate do not slow down or halt the FL process, because now they are simply not involved, and the parameter server need not wait for data to arrive from these UEs.

Furthermore, the UEs which are able to perform FL, and which are selected to perform a specific FL task, are grouped into clusters to reduce the impact of poor communication channel conditions which may lead to individual UEs becoming stragglers. This is because redundancy is built into each cluster, which means that if any UE within a cluster is unable to transmit data to the parameter server, information received from other UEs within the cluster compensates for the missing information. As explained in more detail below, the UEs within a cluster share information with each other, and the UEs perform the FL task using their own information and the information received from other UEs. As a result, advantageously, if a given UE is unable to transmit data to the parameter server, the parameter server may still obtain information needed to update the ML model from as many UEs as possible, including the stragglers.

The scheduler may be configured to store information about the plurality of subscribing UEs that have each subscribed to perform at least one FL task. The information about each UE may include information about the hardware specifications of the UE, and the computing resources which can be allocated to perform FL tasks. This is advantageous because, as noted above, the scheduler can then assign specific FL tasks to UEs which have explicitly stated that they can participate in one or more FL processes. This also means that the scheduler is able to avoid overloading any UEs which have indicated they are able to participate in multiple FL tasks, because the scheduler keeps track of which UEs are being used to perform any live FL tasks. Similarly, if performing a specific FL task requires a certain amount of random access memory (RAM), compute resource or storage of the UE, then the scheduler can ensure that only those UEs which have that RAM, compute resource or storage available for FL tasks are assigned to a specific task.

The scheduler may be configured to receive, from the at least one module, a request to run or re-run an FL task with respect to a specific ML model, the request specifying at least one condition to be satisfied by UEs performing the requested FL task; determine, using the stored information about the plurality of subscribing UEs, whether the at least one condition is satisfied by the plurality of subscribing UEs; and transmit, to the module, a response indicating whether the request is granted based on the determination. Thus, whenever one of the modules wishes to run or re-run an FL process with respect to a specific ML model, the module sends a request to the scheduler. The request includes information about the FL process to be conducted with respect to the ML model. The information specifies at least one condition to be satisfied by the UEs that will participate in the FL process. The condition(s) may vary per training round and/or per ML model.

The at least one condition may specify any one or more of a quality of service (QOS) profile; a minimum number of UEs required to perform the FL task; and a UE hardware capacity requirement for performing the FL task.

The system may further include a coordinator for coordinating the execution of FL tasks by the UEs in each cluster. The coordinator may be configured to receiving, from the scheduler, the clustering policy and selected set of UEs; grouping the selected set of UEs into a plurality of clusters according to the clustering policy; and determining a per-cluster data coding optimization policy to be used by each UE in the plurality of clusters when performing the FL task, wherein the per-cluster data coding optimization policy defines how UEs within each cluster transmit data. The coordinator may be located closer to the UEs in the cellular network, such that the coordinator is able to directly or indirectly communicate with UEs. This is particularly important given that UEs may find it difficult, due to poor communication channel conditions, to communicate with the scheduler directly or frequently. Advantageously, the coordinator implements the clustering policy set by the scheduler, as the coordinator also knows more about the UEs. For example, as explained in more detail below, the clustering policy may specify that each cluster of UEs must only contain UEs which are connected to the same node/base station within the cellular network—this information may be known to the coordinator. Once the UEs have been grouped into clusters, the coordinator determines a per-cluster coding optimization policy based on characteristics of each cluster. This is advantageous because the coding optimization is performed per cluster, rather than for all UEs, which can help to reduce the number of stragglers, as explained in more detail below.

The coordinator may be further configured to periodically re-group, after a pre-defined time period, the selected set of UEs into a plurality of clusters according to the clustering policy, while the FL task is being executed; and re-determine, after the re-grouping, a per-cluster data coding optimization policy to be used by each UE in the plurality of clusters when performing the FL task. This is advantageous because the UEs may move around within a cellular network such that they are no longer connected to the same node as when they were first grouped into clusters for a particular FL task. Thus, it is useful to regroup the UEs to ensure the clustering policy is satisfied throughout the execution of the FL task. Once the re-grouping has been performed (which may not, in some cases, result in any change to the clusters), the per-cluster data coding optimization policy is determined again for each cluster. The regrouping may happen immediately at the end of each pre-defined time period. Preferably, the regrouping may happen when a training iteration/round of the FL task has been completed, rather than mid-way through a training iteration/round.

The clustering policy may specify that UEs in a cluster must be served by a single node. In this case, the coordinator may be configured to group the selected set of UEs into a plurality of clusters based on which node each UE is currently served by.

The coordinator may be configured to transmit, to the scheduler, information about which UEs are in each cluster for the FL task, so that the scheduler is able to instruct the UEs in each cluster to perform the FL task. This may occur every time the clustering/re-clustering operation is performed by the coordinator.

The FL task may include performing a plurality of training iterations/rounds. Before a training iteration begins with respect to the FL task, the scheduler may be configured to check status messages received from the UEs in the plurality of clusters to determine whether the UEs are still able to perform the training iteration of the FL task; and instruct, responsive to determining at least one UE is unable to perform the training iteration of the FL task, the coordinator to re-group the UEs into a plurality of clusters according to the clustering policy and the UE status messages. Thus, the scheduler may determine whether the UEs that were originally selected to perform the FL task are still able to do so, which advantageously reduces the number of potential stragglers. The scheduler may determine whether UEs are able to perform a training iteration from the status messages in two ways: the status messages may indicate whether UEs are able to perform the training, and/or the absence of a status message may indicate a UE is unable to perform the training. In the latter case, when a status message is not received from a UE within a certain time period, the scheduler assumes a UE may have poor communication channel conditions or no longer has the resources needed to perform the FL task.

When the scheduler determines at least one UE is now unable to perform the FL task, the coordinator may be further configured to re-group, in response to a command from the scheduler, some or all of the selected set of UEs into a plurality of clusters according to the clustering policy, while the FL task is being executed; and re-determine, after the re-grouping, a per-cluster data coding optimization policy to be used by each UE in the plurality of clusters when performing the FL task. Thus, the coordinator performs the re-grouping periodically during the execution of an FL task and/or in response to commands from the scheduler. This ensures that, for example, a cluster always contains at least one UE which is able to perform the FL task, and that clusters only contain UEs which are still able to perform the FL task.

The coordinator may determine a per-cluster data coding optimization policy based on, in each cluster, a communication capability of a UE which is experiencing poorest communication channel conditions out of all the UEs in the cluster. Advantageously, this improves the chances of the UE, which is experiencing the worst channel conditions, being able to perform the FL task.

The coordinator may instruct each UE in each cluster to use the per-cluster data coding optimization policy when performing the FL task.

In some cases, when the UEs have been instructed to perform the FL task, each UE in a cluster may be configured to generate, for at least one training data item stored on the UE, a coded training data item, based on the per-cluster data coding optimization policy; and multicast the at least one generated coded training data item to the UEs in the cluster. That is, each UE may provide their coded training data item(s) to the other UEs in the cluster directly.

Alternatively, when the UEs have been instructed to perform the FL task, each UE in a cluster may be configured to generate, for at least one training data item stored on the UE, a coded training data item, based on the per-cluster data coding optimization policy; and transmit the at least one generated coded training data item to a node/base station connected to the UEs in the cluster, for distribution to the UEs in the cluster. That is, each UE may provide their coded training data item(s) to the other UEs in the cluster indirectly.

The FL task involves training, at each UE, a local version of a global ML model In any case, each UE may be further configured to generate a first set of model parameters, by training a local version of the ML model corresponding to the FL task using the at least one training data item stored on the UE; generate a second set of model parameters, by training the local version of the ML model corresponding to the FL task using the at least one generated coded training data item generated by the UE and the at least one generated coded training data item received from other UEs in the cluster; and transmit the first and second sets of model parameters to the at least one module, via the scheduler. In other words, each UE generates, by performing an FL process on-device, two sets of parameters. The first set of parameters is generated using the UE's own training data, while the second set of parameters is generated using all of the coded training data items received from the cluster (including the UE's own coded training data item(s)). Advantageously, this introduces some redundancy into the FL process which mitigates the problem of stragglers. This is because the second set of parameters relate to the whole cluster, and so even if one or more UEs in the cluster are unable to transmit any data/parameters to the parameter server, the parameter server receives information from the whole cluster via the second set of parameters received from other UEs in the cluster. In this way, the parameter server is able to update the ML model using data from the whole of (or most of) the cluster, even when individual UEs may suffer from poor channel conditions.

The at least one module of the parameter server which has requested the FL process to be run/re-run may be configured to update the ML model corresponding to the FL task that has been performed by the UEs using the first and second sets of parameters received from each UE.

When the first set of parameters have been received from a pre-defined minimum number of UEs from the plurality of clusters within a pre-defined time period, the at least one module may be configured to update the ML model by aggregating the first set of parameters received from the UEs in the plurality of clusters; and updating the global ML model using the aggregated first set of parameters. That is, the first set of parameters is prioritized or preferred, because they have been generated directly by each UE using its own raw training data. The first set of parameters may come from the pre-defined minimum number of UEs across the plurality of clusters. In other words, as long as the first set of parameters is received from the minimum number of UEs, it does not matter which cluster or clusters they are received from.

In cases when the first set of parameters has been received from fewer than a pre-defined minimum number of UEs from the plurality of clusters within a pre-defined time period, the at least one module may be configured to update the ML model by aggregating the first set of parameters received from the UEs in the plurality of clusters; aggregating a random selection of the second set of parameters received from the UEs; and updating the global ML model using the aggregated first set of parameters and the aggregated random selection of the second set of parameters. In this way, the missing first set(s) of parameters from UEs in the cluster is compensated for using the second set(s) of parameters.

In cases when the second set of parameters has been received from fewer than a pre-defined minimum number of UEs in a cluster within a pre-defined time period, the at least one module is configured to terminate the updating of the ML model. That is, if insufficient data is received from a cluster, the FL task may be terminated to avoid any negative impact on the ML model.

The cellular network may be any cellular telecommunications network. For example, the cellular network may be a 5G or 6G or next-generation cellular network.

In one example, the cellular network may be an open radio-access network (ORAN). In this case, the parameter server may be a service management and orchestration (SMO) platform including a non-real time radio intelligent controller (non-RT-RIC); the at least one module for updating the at least one ML model may be a software application (rApp) configured to run on the non-RT-RIC; the scheduler may be a software application configured to run on the non-RT-RIC; and the coordinator may be a software application configured to run on a near-real time radio intelligent controller (near-RT-RIC) which controls nodes of the cellular network.

In a second approach of this disclosure, there is provided a user equipment (UE) in a cellular network, for training machine learning (ML) models using federated learning (FL). The UE includes storage storing a plurality of training data items; and at least one processor coupled to memory and configured to receive a data coding optimization policy; receive, from a parameter server, instructions to perform an FL task with respect to an ML model; generate, for at least one training data item in the storage, a coded training data item, based on the received data coding optimization policy; and transmit the at least one generated coded training data item to a defined cluster of UEs.

Features described with respect to the UE in the first approach apply equally to the second approach, and are therefore not repeated.

The at least one processor of the UE may be configured to generate a first set of model parameters, by training a local version of the ML model using the at least one training data item stored on the UE; generate a second set of model parameters, by training a local version of the ML model using the at least one generated coded training data item generated by the UE and at least one generated coded training data item received from other UEs in the cluster of UEs; and transmit the first and second sets of model parameters to the parameter server.

The at least one processor of the UE may be configured to transmit a subscription request to the parameter server, indicating the UE is able to perform at least one FL task; and periodically transmit status update messages to the parameter server.

The UE may be a constrained-resource device, but which has the minimum hardware capabilities to train an ML model and which communicates via a cellular network. The UE may be any one of a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of things device, or a smart consumer device (such as a smart fridge or appliance). It will be understood that this is a non-exhaustive and non-limiting list of example UEs.

In a third approach of this disclosure, there is provided a parameter server in a cellular network for training ML models using FL, the parameter server including at least one ML model for training; at least one module for updating the at least one ML model in response to an FL task being executed; and a scheduler for managing execution of FL tasks in the cellular network, wherein for each FL task, the scheduler is configured to select a set of UEs from a plurality of UEs in the cellular network as being suitable for performing the FL task; define at clustering policy for the FL task, which specifies how to group together the selected set of UEs into a plurality of clusters; and instruct each cluster of the plurality of clusters to perform the FL task.

Features described with respect to the parameter server in the first approach apply equally to the third approach, and are therefore not repeated for the sake of conciseness.

In a fourth approach of this disclosure, there is provided a method for training machine learning (ML) models using federated learning (FL) in a cellular network. The method includes receiving a request to run or re-run an FL task with respect to a specific ML model; selecting a set of user equipments (UEs) from a plurality of subscribing UEs in the cellular network as being suitable for performing the FL task, where each subscribing UE has subscribed to perform at least one FL task; defining a clustering policy for the FL task, which specifies how to group together the selected set of subscribing UEs into a plurality of clusters; and instructing each cluster of the plurality of clusters of subscribing UEs to perform the FL task.

The method may further include transmitting, to a coordinator for coordinating the execution of FL tasks by the UEs in each cluster, a request to determine a per-cluster data coding optimization policy to be used by each UE in the plurality of clusters when performing the FL task, wherein the per-cluster data coding optimization policy defines how UEs within each cluster transmit data.

Features described with respect to the parameter server in the first approach apply equally to the fourth approach, and are therefore not repeated for the sake of conciseness.

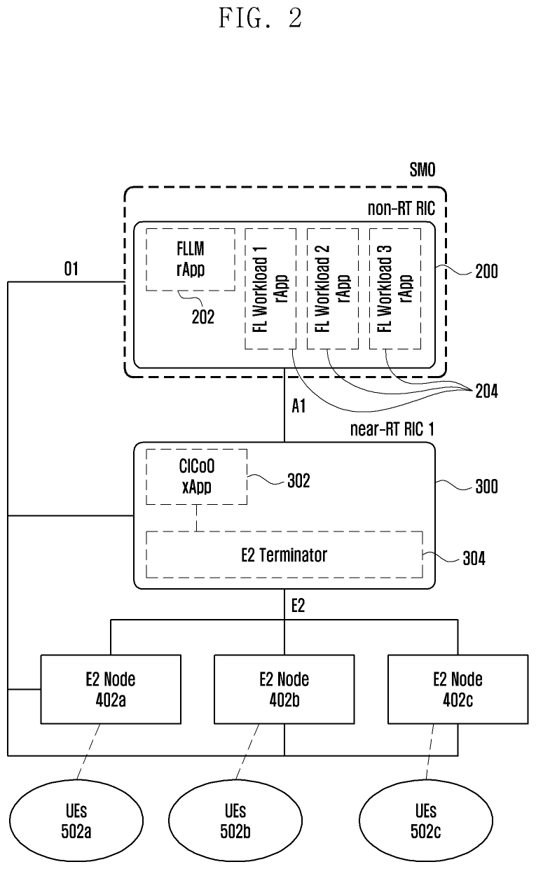

FIG. 2 shows a system for training ML models using FL in a cellular network, according to an embodiment. Here, the cellular network is shown as being an ORAN. It will be understood that this is simply one non-limiting, illustrative example type of a cellular network in which the embodiments of the disclosure may be implemented.

The system includes a plurality of UEs, some of which have explicitly subscribed to partake in an FL workload. That is, not all of the UEs in the system will perform an FL workload. Specifically, the system comprises a plurality of subscribing UEs, where each subscribing UE has subscribed to perform at least one FL task, and a plurality of non-subscribing UEs, where each non-subscribing UE has not subscribed to perform at least one FL task. Referring to FIG. 2, there are a plurality of subscribing UEs 502a, 502b, 502c. It will be understood that there may be tens, hundreds or thousands of subscribing and non-subscribing UEs within the system and that only three subscribing UEs are shown here for the sake of simplicity. Furthermore, the UEs shown here are participating in FL—there may be other UEs in the system that do not participate in FL (at all, or with respect to specific FL tasks).

The term “FL task” is used interchangeably herein with the term “FL workload”

The UEs may be any electronic device which communicates via a cellular network. Some or all of the UEs may be constrained-resource devices, but which have the minimum hardware capabilities to train an ML model and which communicate via a cellular network. The UEs may be any one of a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of things device, or a smart consumer device (such as a smart fridge or appliance). It will be understood that this is a non-exhaustive and non-limiting list of example UEs.

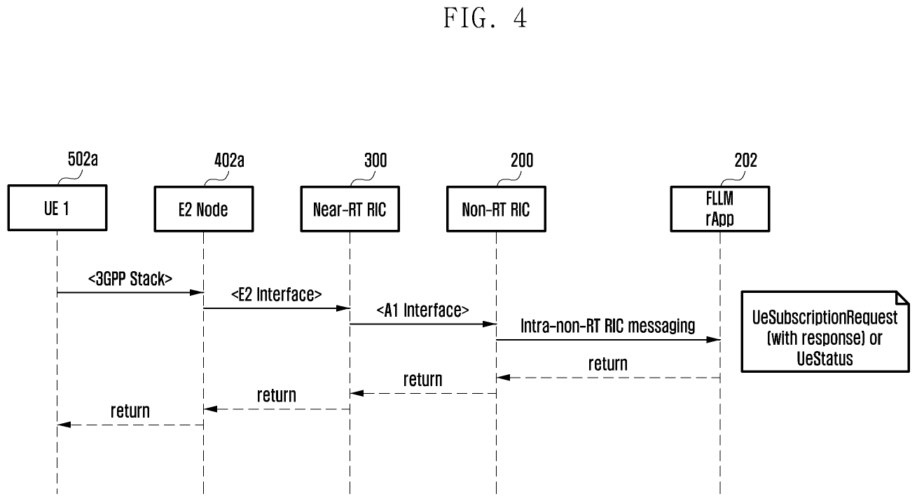

Each of UEs 502a-502c has subscribed to perform at least one FL task. The subscription process is described in more detail below with respect to FIG. 4.

The system includes a parameter server for controlling the training of ML models by the cellular network. In this example, the parameter server may be a service management and orchestration (SMO) platform having a non-real time radio intelligent controller (non-RT-RIC) 200.

The parameter server includes at least one global ML model for training; and at least one module 204 for updating the at least one global ML model in response to an FL task being executed. In this example, the at least one module 204 may be an “FL workload rApp”, which is a software application configured to run on the non-RT-RIC 200. In FIG. 2, three modules 204 are shown, but it will be understood there may be any non-zero number of modules 204. Each module 204 implements a specific FL task with respect to a specific ML model. For example, one module 204 may implement an FL task with respect to an image classification ML model, while another module 204 may implement an FL task with respect to a speech recognition ML model. As mentioned above, the term “FL task” is used interchangeably herein with the term “FL workload”. The FL task or workload is to train a specific ML model. The training process involves training a local version, at each participating UE, of the global ML model.

The parameter server includes a scheduler 202 for managing execution of FL tasks in the cellular network. In this example, the scheduler 202 may be called an “FL lifecycle manager (FLLM) rApp”, which is a software application configured to run on the non-RT-RIC 200. As explained in more detail below, the scheduler 202 oversees the creation/run to completion of an FL workload, oversees the subscription process of a pool of UEs wishing to take part in an FL workload, and enforces a clustering policy to be adopted in the system.

For each FL task, the scheduler 202 is configured to select a set of UEs from the plurality of subscribing UEs 502a-502c as being suitable for performing an FL task (requested by a module 204); define a clustering policy for the FL task, which specifies how to group together the selected set of UEs into a plurality of clusters; and instruct each cluster of the plurality of clusters to perform the FL task.

As shown in FIG. 2, this disclosure extends the non-RT RIC functionalities by adding an FLLM rApp, which supports one or more FL workloads. Each FL workload is run by an rApp. From a logic point of view, an rApp wishing to run an FL workload and the FLLM rApp together act as a parameter server.

UEs 502a-502c wishing to take part in an FL workload must first subscribe to the scheduler 202. The UEs communicate with the scheduler 202 via other components in the cellular network, and in particular, via the E2 node/base stations to which they are connected. Here, UE 502a is connected to E2 node 402a, UE 502b is connected to E2 node 402b, and UE 502c is connected to E2 node 402c. However, it will be understood that multiple UEs may be connected to one E2 node, and some E2 nodes may not be connected to any UEs. UEs may also connect to different E2 nodes because the UEs may be mobile and therefore move into different geographical locations.

The scheduler 202 may be configured to store information about the plurality of subscribing UEs 502a-502c that have each subscribed to perform at least one FL task. The information about each subscribing UE may include information about the hardware specifications of the UE, and the computing resources which can be allocated to perform FL tasks. This is advantageous because, as noted above, the scheduler 202 can then assign specific FL tasks to subscribing UEs which have explicitly stated that they can participate in one or more FL processes. This also means that the scheduler is able to avoid overloading any subscribing UEs which have indicated they are able to participate in multiple FL tasks, because the scheduler keeps track of which subscribing UEs are being used to perform any live FL tasks. Similarly, if performing a specific FL task requires a certain amount of RAM, compute resource or storage of the subscribing UE, then the scheduler can ensure that only those subscribing UEs which have that RAM, compute resource or storage available for FL tasks are assigned to a specific task.

The scheduler 202 may be configured to receive, from the at least one module 204, a request to run or re-run an FL task with respect to a specific ML model, the request specifying at least one condition to be satisfied by UEs performing the requested FL task; determine, using the stored information about the plurality of subscribing UEs, whether the at least one condition is satisfied by the plurality of subscribing UEs; and transmit, to the module, a response indicating whether the request is granted based on the determination. Thus, whenever one of the modules 204 wishes to run or re-run an FL process with respect to a specific ML model, the module 204 sends a request to the scheduler 202. The request includes information about the FL process to be conducted with respect to the ML model. The information specifies at least one condition to be satisfied by the subscribing UEs that will participate in the FL process. The condition(s) may vary per training round and/or per ML model.

The at least one condition may specify any one or more of: a QoS profile; a minimum number of UEs required to perform the FL task; and a UE hardware capacity requirement for performing the FL task.

The system may further include a coordinator 302 for coordinating the execution of FL tasks by the UEs in each cluster. In this example, the coordinator 302 may be a “clustering and code optimization (CICOO) xApp”, which is a software application configured to run on a near-real time radio intelligent controller (near-RT-RIC) 300 which controls nodes 402a-402c of the cellular network. The coordinator 302 is responsible for the clustering of a pool of subscribing UEs taking part in a specific FL workload (based on the clustering policy enforced by the scheduler 202), and a per-cluster optimization of a chosen random code.

The coordinator 302 may be configured to receive, from the scheduler 202, the clustering policy and selected set of UEs; group the selected set of UEs into a plurality of clusters according to the clustering policy; and determine a per-cluster data coding optimization policy to be used by each UE in the plurality of clusters when performing the FL task, wherein the per-cluster data coding optimization policy defines how UEs within each cluster transmit data. The coordinator 302 may be located closer to the UEs in the cellular network, such that the coordinator is able to directly or indirectly communicate with UEs. This is particularly important given that UEs may find it difficult, due to poor communication channel conditions, to communicate with the scheduler directly or frequently. Advantageously, the coordinator implements the clustering policy set by the scheduler, as the coordinator also knows more about the UEs. For example, as explained in more detail below, the clustering policy may specify that each cluster of UEs must only contain UEs which are connected to the same node/base station within the cellular network—this information may be known to the coordinator. Once the UEs have been grouped into clusters, the coordinator determines a per-cluster coding optimization policy based on characteristics of each cluster. This is advantageous because the coding optimization is performed per cluster, rather than for all UEs, which can help to reduce the number of stragglers, as explained more below.

The overall FL process is summarized with respect to FIG. 2 before explaining details of the process. The summary refers to components in the ORAN system but it will be understood that it applies equally to other similar network types. UEs 502a-502c wishing to take part in an FL workload subscribe to the scheduler 202 via the node 402a-402c to which they are connected. The subscription message transmitted by a UE is forwarded over the E2 interface across an E2 terminator 304 of a relevant near real-time RIC (near-RT RIC) 300, and then to the SMO/Non-RT RIC 200 over the AI interface. Subsequently, the scheduler 202 communicates (via the AI interface) with a set of near-RT RICs 300 (which control the nodes 402a-402c that serve each UE wishing to take part in an FL workload), a clustering policy to be enforced by their coordinators 302. The coordinators 302 optimize the random code on a per-cluster basis (the optimized coding parameters are communicated to E2 nodes and then to the UEs via the E2 interface). This disclosure makes provisions for the scheduler 202 to periodically trigger the re-optimization of both the clusters and the coding parameters during the execution of an FL workload.

During each learning step, each UE generates and multicasts coded examples within the cluster it belongs to. Furthermore, each UE transmits, to the module 204 running the FL workload (via the scheduler 202), both the parameters calculated using locally available training examples, and parameters calculated using locally-generated coded examples (which includes coded examples that might have been received from other UEs belonging to the same cluster). The module 204 running the FL workload combines the parameters and updates the global parameters of the ML model. The parameters of the updated ML model are then redistributed to the UEs via the scheduler 202 and the nodes 402a-402c (this last step is made possible by employing the O1 interface).

Before explaining the FL process in detail, it is necessary to explain some underlying assumptions. The FL process is based on a system model including a set of W>0 UEs U={u₁, u₂, . . . , u_{w}}. The UEs are not necessarily connected to the same E2 node. The subset of the plurality of UEs which take part in the i-th FL workload is F^{(q)} ⊆U for i=1, . . . , F.

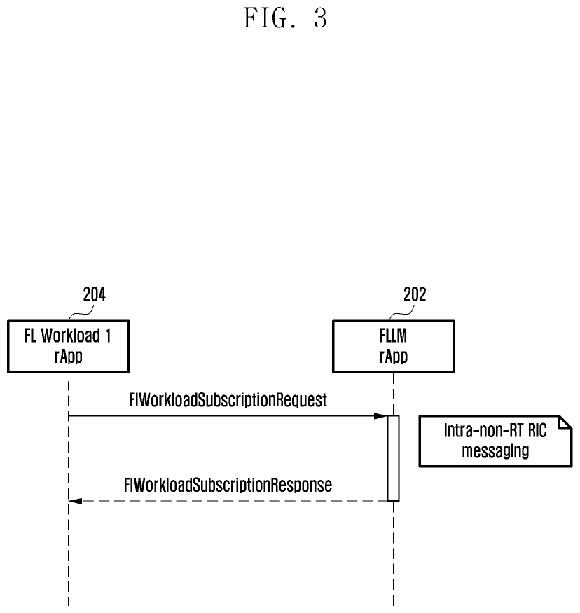

FIG. 3 is a schematic diagram illustrating a process to create and execute an FL task according to an embodiment.

Referring to FIG. 3, as soon as a module 204 wishes to run/re-run an FL workload, the module 204 sends an FlWorkloadSubscriptionRequest message to the scheduler 202. Thus, the scheduler 202 may be configured to receive, from the at least one module 204, a request to run or re-run an FL task with respect to a specific ML model, the request specifying at least one condition to be satisfied by UEs performing the requested FL task.

The request may contain some or all of the following information, though it will be understood that this is a non-limiting, non-exhaustive list of information that could be included in a request:
Requested Quality-of-Service (QOS) profile—The level of QOS associated with the end-to-end communications between the UEs involved in the FL workload and the module 204 backing the FL workload;
Sorted list of stopping criteria—Sorted from the highest to lowest stopping criteria, which may include the maximum number of learning steps, loss function criteria, timer, etc.;
Minimum number of requested UEs—Minimum number of UEs that are expected to take part in the FL workload;
Minimum/Maximum amount of resources (e.g., memory and CPU footprint) to be reserved by each UE involved in the FL workload;
List of UE clustering criteria—The list of clustering criteria (sorted from the highest to the lowest priority);
Random code parameters—The list of fundamental parameters of the code to be used that are not going to be optimized. For instance, if the random linear network coding (RLNC) code is used, the rApp backing the FL workload may specify the size of the Galois field or finite field to be used (e.g., 2, 28);

Upon receiving an FlWorkloadSubscriptionRequest, the scheduler 202 may respond with one of the following messages:
Positive FlWorkloadSubscriptionResponse—this is sent in the case where the scheduler 202 has received enough subscription requests from UEs willing to take part in FL workloads. As such, enough resources can be found in the pool of UEs to accommodate the new FL workload.
Negative FlWorkloadSubscriptionResponse—this is sent in the case where the scheduler 202 does not have access to enough UEs and/or resources across the pool of UEs to accommodate the new FL workload. In this case, the module 204 wishing to run/re-run the FL workload can send another FlWorkloadSubscriptionRequest message at a later stage.

Thus, the scheduler 202 may be configured to determine, using the stored information about the plurality of UEs, whether the at least one condition is satisfied by the UEs; and transmit, to the requesting module 204, a response indicating whether the request is granted based on the determination. Thus, whenever one of the modules wishes to run or re-run an FL process with respect to a specific ML model, the module sends a request to the scheduler. The request includes information about the FL process to be conducted with respect to the ML model. The information specifies at least one condition to be satisfied by the UEs that will participate in the FL process. The condition(s) may vary per training round and/or per ML model.

FIG. 4 is a schematic diagram illustrating a process for UEs to communicate subscription requests and status updates to the scheduler 202, according to an embodiment.

Referring to FIG. 4, from the perspective of a UE 502a-502c, the end-point/source of any message originating/directed to the scheduler 202 is part of an application that may run as part of the operating system of the UE (such as a device driver, a memory manager or a garbage collector) or in the user-space (such as an Android or iOS app). Each UE willing to participate in FL workloads shall submit (e.g., via E2 and AI interfaces) a subscription request (UeSubscriptionRequest) to the scheduler 202. As a part of the subscription request, the UE may include any of the following information, although it will be understood that this is a non-limiting, non-exhaustive list of information that could be included in a subscription request:
The hardware peripherals (also known as tensor processing units or TPUs) that the UE may be equipped with that are suitable to support tensor-related operations; and
The maximum amount of RAM and storage that the UE can allocate for running FL workloads.

As soon as the scheduler 202 receives a UeSubscriptionRequest message, the UE is added to the pool of UEs willing to take part in FL workloads. UeSubscriptionRequest messages are always followed by an acknowledgement message from the scheduler 202, as shown in FIG. 3.

Periodically, each UE that has successfully subscribed to the scheduler 202 (via a UeSubscriptionRequest message) communicates its status (via the UeStatus message) to the scheduler rApp containing any of the following information, though it will be understood that this is a non-limiting, non-exhaustive list of information that could be included in a status message:
Number of active FL workloads the UE is taking part in;
Available computational, memory and storage resources; and
List of Segment/Packet/service data unit (SDU)/packet data unit (PDU) error rates-averaged over a given time interval, calculated in uplink/downlink at different points in the protocol stack (including but not limited to the application and network layers).

The UeStatus messages may be delivered to the scheduler 202 via the E2 node, E2 and AI interfaces, or via the E2 node and O1 interface.

The UeStatus messages are used by the scheduler 202 to trigger a per-cluster code optimization or a global re-clustering of the UEs taking part in an FL workload.

Thus, the coordinator 302 may be further configured to periodically re-group, after a pre-defined time period, the selected set of UEs into a plurality of clusters according to the clustering policy, while the FL task is being executed; and re-determine, after the re-grouping, a per-cluster data coding optimization policy to be used by each UE in the plurality of clusters when performing the FL task. This is advantageous because the UEs may move around within a cellular network such that they are no longer connected to the same node as when they were first grouped into clusters for a particular FL task. Thus, it is useful to regroup the UEs to ensure the clustering policy is satisfied throughout the execution of the FL task. Once the re-grouping has been performed (which may not, in some cases, result in any change to the clusters), the per-cluster data coding optimization policy is determined again for each cluster.

The clustering/re-clustering procedure is now explained.

Pre-Conditions: Consider the i-th FL workload. The scheduler has selected the set F⁽ⁱ⁾ of UEs as the UEs expected to take part in the considered FL workload. The entity running the clustering procedure is the coordinator 302. The clustering procedure is run under the following conditions: (i) run/re-run as a result of a command sent by the scheduler 202 to the coordinator 302 (via the AI interface); and/or run/re-run when a given timer \tilde{T}_{c}⁽ⁱ⁾ expires. The clustering procedure is performed with respect to a subset of UEs in F(served by nodes 402a-402c registered to the same near-RT RIC 300.

The clustering procedure works as follows. The scheduler 202 triggers the execution of the procedure by a message containing a clustering profile (defined by a list of clustering criteria chosen by the module 204 running the FL workload). Regardless of the communicated cluster profile, the set of UEs within the scope of this procedure is clustered ensuring that the following criteria are met:
UEs served by different E2 nodes shall not be part of the same cluster;
UEs served by the same E2 node can be clustered into one or more clusters; and
A cluster cannot be empty.

The result of the clustering procedure is the return of a set of clusters c^{(i,r)}={c₁^{(i,r)}, c₂^{(i,r)}, . . . }, where cⱼ^{(i,r)} is defined by the list of UEs forming the j-th cluster pertaining to the i-th FL workload and the r-th near-RT RIC. The cluster set, known to the relevant coordinator(s) 302, is then communicated to the scheduler 202 via the AI interface.

The code optimization/re-optimization procedure is now explained.

Pre-Conditions: The coordinator 302 has completed the clustering of the UEs under its direct control. The entity running the code optimization procedure is the coordinator 302. The code optimization procedure is run under the following conditions: (i) run/re-run as a result of a command sent by the scheduler 202 to the coordinator 302 (via the AI interface); and/or (ii) run/re-run when a given timer T̅_{( )}^{(i,j)} expires. The code optimization procedure is performed with respect to the UEs in a given cluster cⱼ^{(i,r)}.

The code optimization procedure works as follows. The scheduler 202 triggers the execution of the procedure by a message containing:
the highest PDU error rate ∈* amongst the UEs in the considered cluster; and
the random code overhead factor Ō.

The result of the code optimization procedure is the return of an overall coding overhead (∈+Ō) to be adopted by all the UEs within the cluster. The overall coding overhead is only known to the coordinator 302 that runs the procedure and the UEs in the scope of this procedure.

Remark 1: It is observed that the actual number of coded examples to be generated by a UE t part of cluster Cⱼ^{(i,r)} is [lₜ^{ij}(∈*+Ō)], where lₜ^{ij} is the number of training examples stored at the UE side.

The coordinator may be configured to transmit, to the scheduler, information about which UEs are in each cluster for the FL task, so that the scheduler is able to instruct the UEs in each cluster to perform the FL task. This may occur every time the clustering/reclustering operation is performed by the coordinator.

The FL task may include performing a plurality of training iterations/rounds. Before a training iteration begins with respect to the FL task, the scheduler may be configured to check status messages received from the UEs in the plurality of clusters to determine whether the UEs are still able to perform the training iteration of the FL task; and instruct, responsive to determining at least one UE is unable to perform the training iteration of the FL task, the coordinator to re-group the UEs into a plurality of clusters according to the clustering policy and the UE status messages. Thus, the scheduler may determine whether the UEs that were originally selected to perform the FL task are still able to do so, which advantageously reduces the number of potential stragglers. The scheduler may determine whether UEs are able to perform a training iteration from the status messages in two ways: the status messages may indicate whether UEs are able to perform the training, and/or the absence of a status message may indicate a UE is unable to perform the training.

When the scheduler determines at least one UE is now unable to perform the FL task, the coordinator may be further configured to re-group, in response to a command from the scheduler, some or all of the selected set of UEs into a plurality of clusters according to the clustering policy, while the FL task is being executed; and re-determine, after the re-grouping, a per-cluster data coding optimization policy to be used by each UE in the plurality of clusters when performing the FL task. Thus, the coordinator performs the re-grouping periodically during the execution of an FL task and/or in response to commands from the scheduler.

The coordinator may determine a per-cluster data coding optimization policy based on, in each cluster, a communication capability of a UE which is experiencing poorest communication channel conditions out of all the UEs in the cluster. Advantageously, this improves the chances of the UE which is experiencing the worst channel conditions being able to perform the FL task.

The coordinator may instruct each UE in each cluster to use the per-cluster data coding optimization policy when performing the FL task.

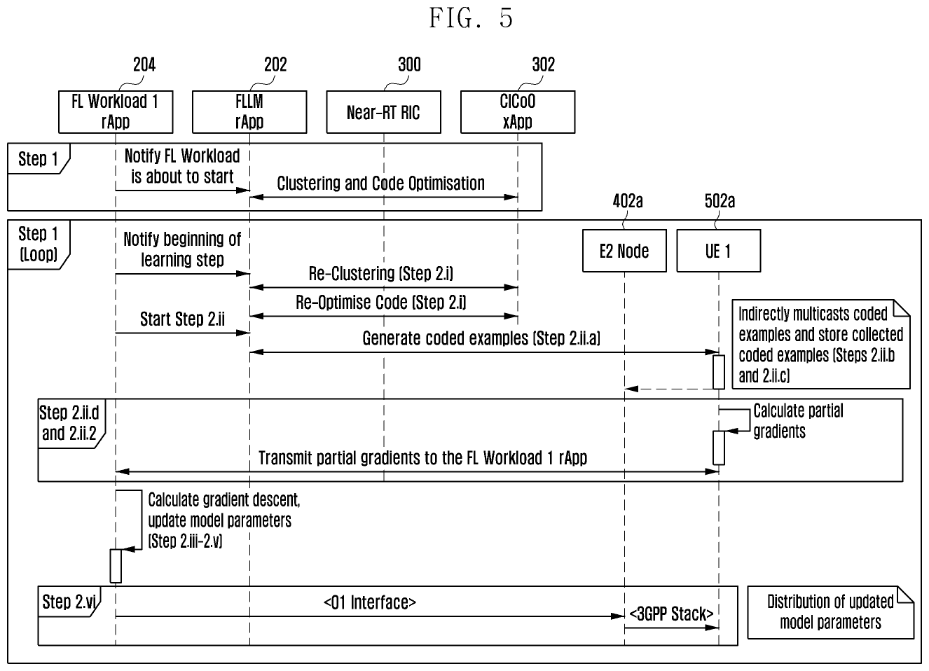

FIG. 5 is a schematic diagram illustrating a process to perform FL within a cellular network, according to an embodiment.

Pre-Conditions: Consider the i-th FL workload. The scheduler 202 has selected the set F(i) of UEs as the UEs expected to take part in the considered FL workload. This FL procedure is to be run/re-run potentially until the FL workload succeeds, and involves all the UEs in Fit).

The process begins when a module 204 notifies the scheduler 202 of the intention to begin the distributed learning process. In turn, the scheduler 202 triggers the clustering and code optimization procedures described above across all the near-RT RICs controlling E2 nodes serving UEs taking part in the FL workload.

Thus, for each training step trainingStep=1, . . . , Ŝ, where Ŝ is the maximum number of training steps, the module 204 is configured to notify the scheduler 202 that a new training step is about to begin.

In response, and on the basis of changes in the current pool of available resources communicated to the scheduler 202 via UeStatus messages from UEs, the scheduler 202 may trigger a code re-optimization over a number of clusters, or re-clustering and a code re-optimization across all the clusters.

The module 204 responsible for running the i-th FL workload may request the scheduler that each UE in F⁽ⁱ⁾ generates a number of coded examples according to the chosen random code as per Remark 1.

In response, when the UEs have been instructed to perform the FL task, each UE in a cluster may be configured to generate, for at least one training data item stored on the UE, a coded training data item, based on the per-cluster data coding optimization policy; and multicast the at least one generated coded training data item to the UEs in the cluster. That is, each UE may provide their coded training data item(s) to the other UEs in the cluster directly.

Alternatively, when the UEs have been instructed to perform the FL task, each UE in a cluster may be configured to generate, for at least one training data item stored on the UE, a coded training data item, based on the per-cluster data coding optimization policy; and transmit the at least one generated coded training data item to a node/base station connected to the UEs in the cluster, for distribution to the UEs in the cluster. That is, each UE may provide their coded training data item(s) to the other UEs in the cluster indirectly.

Thus, each UE either indirectly or directly communicates the generated coded examples to all the other UEs belonging to the same cluster. Each UE locally stores the coded examples that it has successfully received from the other cluster members. The UEs may further manipulate the received coded examples (potentially including locally generated coded examples). The stored coded examples constitute a coded training set of a UE.

Each UE calculates and transmits to the module 204 running the FL workload (via the scheduler 202) the partial gradients over the locally stored training examples. Each UE also calculates and transmits to the module 204 running the FL workload (via the scheduler 202) the partial gradients over the locally stored coded training examples. That is, each UE may be further configured to generate a first set of parameters using the at least one training data item stored on the UE; generate a second set of parameters using the at least one generated coded training data item generated by the UE and the at least one generated coded training data item received from other UEs in the cluster; and transmit the first and second set of parameters to the at least one module, via the scheduler. In other words, each UE generates, by performing an FL process on-device, two sets of parameters. The first set of parameters is generated using the UE's own training data, while the second set of parameters is generated using all of the coded training data items received from the cluster (including the UE's own coded training data item(s)). Advantageously, this introduces some redundancy into the FL process which mitigates the problem of stragglers. This is because the second set of parameters relate to the whole cluster, and so even if one or more UEs in the cluster are unable to transmit any data/parameters to the parameter server, the parameter server receives information from the whole cluster via the second set of parameters received from other UEs in the cluster. In this way, the parameter server is able to update the ML model using data from the whole of (or most of) the cluster, even when individual UEs may suffer from poor channel conditions.

Each partial gradient may be communicated to the module 204 running the FL workload along with auxiliary coding information (e.g., the number of coded examples that the partial gradient has been calculated on).

The calculation of the gradient descent step takes place at the module 204 running the FL workload. That is, the module 204 which has requested the FL process to be run/re-run may be configured to update the ML model corresponding to the FL task that has been performed by the UEs using the first and second set of parameters received from each UE.

When the first set of parameters have been received from a pre-defined minimum number of UEs in a cluster within a pre-defined time period, the at least one module may be configured to update the ML model by using the first set of parameters received from the UEs in the cluster. That is, the first sets of parameters, which do not refer to or relate to coded examples, are prioritized or preferred, because they have been generated directly by each UE using its own raw training data.

Should a number of partial gradients not have arrived by a pre-determined deadline, the partial gradients that are missing are going to be replaced by a random selection of partial gradients calculated over coded examples. That is, in cases when the first set of parameters has been received from fewer than a pre-defined minimum number of UEs in a cluster within a pre-defined time period, the at least one module may be configured to update the ML model by using the first set of parameters received from the UEs in the cluster; and using a random selection of the second set of parameters received from the UEs in the cluster. In this way, the missing first set(s) of parameters from UEs in the cluster are compensated for using the second sets of parameters.

If this is not possible, the FL workload fails and this procedure is terminated. That is, in cases when the second set of parameters has been received from fewer than a pre-defined minimum number of UEs in a cluster within a pre-defined time period, the at least one module is configured to terminate the updating of the ML model. That is, if insufficient data is received from a cluster, the FL task may be terminated to avoid any negative impact on the ML model.

In the cases where the module 204 is able to aggregate the received parameters, the module 204 running the FL workload updates the ML model parameters. If stopping criteria for the FL task (e.g., number of training rounds) are met, the module 204 completes the FL task, and distributes the updated ML model parameters to the UEs taking part in the FL workload via the scheduler 202, the O1 interface connecting the SMO to the relevant E2 nodes, and then to the UEs taking part in the FL workload.

Thus, this disclosure provides a novel rApp (the FLLM rApp/scheduler 202) that oversees the creation/run to completion/destruction of an FL workload; oversees the subscription process of a pool of mobile nodes wishing to take part in an FL workload; and decides the clustering policy to be adopted. This disclosure also provides a novel class of CICOO xApps/coordinators 302 to be deployed in each near-RT RIC with UEs wishing to take part in an FL workload responsible for the clustering (this disclosure is cluster policy-agnostic) of a pool of mobile nodes taking part in an FL workload (based on the clustering policy decided by the FLLM rApp); and per-cluster optimization of the chosen random code (this disclosure is random code-agnostic). This disclosure supports the multicasting of coded training examples to mitigate adverse channel conditions between UEs and their serving E2 nodes.

Furthermore, the embodiments of the disclosure may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of this disclosure may be written in any combination of one or more programming languages, including object-oriented programming languages and conventional procedural programming languages. Code components may be embodied as procedures, methods or the like, and may include sub-components which may take the form of instructions or sequences of instructions at any of the levels of abstraction, from the direct machine instructions of a native instruction set to high-level compiled or interpreted language constructs.

Embodiments of the disclosure also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g., flash memory) or read-only memory (ROM; firmware), or on a data carrier such as an optical or electrical signal carrier. Code (and/or data) to implement embodiments of the techniques described herein may include source, object or executable code in a conventional programming language (interpreted or compiled) such as Python, C, or assembly code, code for setting up or controlling an ASIC (application specific integrated circuit) or FPGA (field programmable gate array), or code for a hardware description language such as Verilog (register transfer module (RTM)) or VHDL (very high speed integrated circuit hardware description language). As a skilled person will appreciate, such code and/or data may be distributed between a plurality of coupled components in communication with one another. The techniques may include a controller which includes a microprocessor, working memory and program memory coupled to one or more of the components of the system.

It will also be clear to one of skill in the art that all or part of a logical method according to embodiments of the disclosure may suitably be embodied in a logic apparatus including logic elements to perform the steps of the above-described methods, and that such logic elements may include components such as logic gates in, for example, a programmable logic array or ASIC. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, this disclosure may be realized in the form of a data carrier having functional data thereon, the functional data including functional computer data structures to, when loaded into a computer system or network and operated upon thereby, enable the computer system to perform all the steps of the above-described method(s).

The methods described above may be wholly or partly performed on an apparatus, i.e., an electronic device, using an ML or AI model. The model may be processed by an AI-dedicated processor designed in a hardware structure specified for AI model processing. The AI model may be obtained by training. Here, “obtained by training” means that a predefined operation rule or AI model configured to perform a desired feature (or purpose) is obtained by training a basic AI model with multiple pieces of training data by a training algorithm. The AI model may include a plurality of neural network layers. Each of the plurality of neural network layers includes a plurality of weight values and performs neural network computation by computation between a result of computation by a previous layer and the plurality of weight values.

As mentioned above, embodiments of the disclosure may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Those skilled in the art will appreciate that while the foregoing has described what is considered to be the best mode and where appropriate other modes of performing embodiments of the disclosure, this disclosure should not be limited to the specific configurations and methods disclosed in this description. Those skilled in the art will recognize that this disclosure has a broad range of applications, and that the embodiments may take a wide range of modifications without departing from any inventive concept as defined in the appended claims.

While this disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A parameter server for training machine learning (ML) models in a cellular network, the parameter server comprising:
at least one ML model for training;
at least one module for updating the at least one ML model as a response to a federated learning (FL) task being executed; and
a scheduler for managing executions of FL tasks in the cellular network, wherein for each FL task, the scheduler is configured to:
select a set of user equipments (UEs), from a plurality of subscribing UEs, as being suitable for performing the FL task,
determine a clustering policy for the FL task, which specifies how to group the selected set of UEs into a plurality of clusters, and
instruct each cluster of the plurality of clusters to perform the FL task.

2. The parameter server of claim 1, wherein the scheduler is further configured to:
store information on the plurality of subscribing UEs that have each subscribed to perform at least one FL task,
receive, from the at least one module, a request to run or re-run an FL task with respect to a specific ML model, the request specifying at least one condition to be satisfied by UEs performing the requested FL task,
determine, using the stored information on the plurality of subscribing UEs, whether the at least one condition is satisfied by the plurality of subscribing UEs, and
transmit, to the at least one module, a response indicating whether the request is granted based on the determination.

3. The parameter server of claim 2, wherein the at least one condition specifies any one or more of a quality of service (QOS) profile, a minimum number of UEs required to perform the FL task, and a UE hardware capacity requirement for performing the FL task.

4. The parameter server of claim 3, wherein the FL task comprises a plurality of training iterations, and before a training iteration begins, the scheduler is configured to:
check UE status messages received from the UEs in the plurality of clusters to determine whether the UEs are still able to perform the training iteration of the FL task, and
instruct, responsive to determining at least one UE is unable to perform the training iteration of the FL task, a coordinator to re-group the UEs into a plurality of clusters according to the clustering policy and the UE status messages.

5. The parameter server of claim 4, wherein the at least one module of the parameter server is configured to:
receive, from a UE via the scheduler, a first set of parameters and a second set of parameters, and
update the ML model corresponding to the FL task that has been performed by the UEs using the first set and the second set,
wherein the first set of parameters is generated based on a training of a local version of the ML model corresponding to the FL task using at least one training data item stored on the UE, and
wherein the second set of parameters is generated based on a training of a local version of the ML model corresponding to the FL task using at least one training data item generated by the UE and at least one generated coded training data item received from other UEs in the cluster.

6. The parameter server of claim 5, wherein when the first set of parameters has been received from a pre-defined minimum number of UEs from the plurality of clusters within a pre-defined time period, the at least one module is configured to update the ML model by:
aggregating the first set of parameters received from the UEs in the plurality of clusters; and
updating the ML model using the aggregated first set of parameters.

7. The parameter server of claim 5, wherein when the first set of parameters has been received from fewer than a pre-defined minimum number of UEs from the plurality of clusters within a pre-defined time period, the at least one module is configured to update the ML model by:
aggregating the first set of parameters received from the UEs in the plurality of clusters;
aggregating a random selection of the second set of parameters received from the UEs; and
updating the ML model using the aggregated first set of parameters and the aggregated random selection of the second set of parameters.

8. The parameter server of claim 7, wherein when the second set of parameters has been received from fewer than a pre-defined minimum number of UEs in a cluster within a pre-defined time period, the at least one module is configured to terminate the updating of the ML model.

9. The parameter server of claim 1, wherein:
the cellular network is an open radio-access network (ORAN),
the parameter server is a service management and orchestration (SMO) platform comprising a non-real time radio intelligent controller (non-RT-RIC),
the at least one module for updating the at least one ML model is a software application (rApp) configured to run on the non-RT-RIC, and
the scheduler is a software application configured to run on the non-RT-RIC.

10. A user equipment (UE) for training machine learning (ML) models in a cellular network, the UE comprising:
a storage storing a plurality of training data items; and
at least one processor coupled to the storage and configured to:
receive a data coding optimization policy,
receive, from a parameter server, instructions to perform a federated learning (FL) task with respect to an ML model,
generate, for at least one training data item in the storage, a coded training data item, based on the received data coding optimization policy, and
transmit the at least one generated coded training data item to a cluster of UEs or to a node connected to the UEs in the cluster.

11. The UE of claim 10, where the at least one processor is further configured to:
generate a first set of parameters, by training a local version of the ML model corresponding to the FL task using at least one training data item stored on the UE,
generate a second set of parameters, by training a local version of the ML model corresponding to the FL task using at least one generated coded training data item generated by the UE and at least one generated coded training data item received from other UEs in the cluster of UEs, and
transmit the first set of parameters and the second set of parameters to the parameter server.

12. The UE of claim 11, wherein the at least one processor is further configured to:
transmit, to the parameter server, a subscription request indicating the UE is able to perform at least one FL task; and
periodically transmit, to the parameter server, status update messages.

13. A method performed by a parameter server for training machine learning (ML) models using federated learning (FL) in a cellular network, the method comprising:
selecting a set of subscribing user equipments (UEs) from a plurality of subscribing UEs in the cellular network as being suitable for performing an FL task, where each subscribing UE has subscribed to perform at least one FL task;
determining a clustering policy for the FL task, which specifies how to group the selected set of subscribing UEs into a plurality of clusters; and
instructing each cluster of the plurality of clusters of subscribing UEs to perform the FL task.

14. The method of claim 13, further comprising:
receiving a request to run or re-run an FL task with respect to a specific ML model.

15. The method of claim 14, further comprising:
transmitting, to a coordinator for coordinating the execution of FL tasks by the UEs in each cluster, a request to determine a per-cluster data coding optimization policy to be used by each UE in the plurality of clusters when performing the FL task, wherein the per-cluster data coding optimization policy defines how UEs within each cluster transmit data.

16. A method performed by a coordinator for training machine learning (ML) models in a cellular network, the method comprising:
receiving, from a parameter server, a clustering policy for a federated learning (FL) task and information on a set of user equipments (UEs); and
grouping the set of UEs into a plurality of clusters based on the clustering policy,
wherein the clustering policy specifies how to group the set of UEs into the plurality of clusters, and
wherein the set of UEs is selected from a plurality of UEs in the cellular network as being suitable for performing the FL task.

17. The method of claim 16, further comprising:
determining a per-cluster data coding optimization policy to be used by each UE in the plurality of clusters when performing the FL task, wherein the per-cluster data coding optimization policy defines how UEs within each cluster transmit data.

18. The method of claim 17, further comprising:
periodically re-grouping, after a pre-defined time period, the set of UEs into a plurality of clusters based on the clustering policy, while the FL task is being executed; and
re-determining, after the re-grouping, a per-cluster data coding optimization policy to be used by each UE in the plurality of clusters when performing the FL task.

19. The method of claim 16, further comprising:
transmitting, to the parameter server, information on which UEs are in each cluster for the FL task, so that the parameter server is able to instruct the UEs in each cluster to perform the FL task.

20. The method of claim 16, wherein the coordinator is a software application configured to run on a near-real time radio intelligent controller (near-RT-RIC) which controls nodes of the cellular network.
